(19) United States
(12) Patent Application Publication
(10) Pub. No.: US 2021/0319735 A1
(43) Pub. Date: Oct. 14, 2021

(54) DRIVING METHOD, DRIVER, AND DISPLAY DEVICE

(71) Applicant: JADARD TECHNOLOGY INC., Shenzhen (CN)

(72) Inventors: CHIEN-SHIANG HONG, Shenzhen (CN); CHIH-TING CHEN, Shenzhen (CN); CHANG ZHU, Shenzhen (CN); BAO-WEI DUAN, Shenzhen (CN); HONG-YUN WEI, Shenzhen (CN); QING-SHAN YAN, Shenzhen (CN); GANG LIU, Shenzhen (CN)

(21) Appl. No.: 17/038,176

(22) Filed: Sep. 30, 2020

(30) Foreign Application Priority Data
Apr. 13, 2020 (CN) 202010287486.7

(51) Int. Cl. G09G 3/20

(52) U.S. Cl. CPC G09G 3/20; G09G 2310/0264

(57) ABSTRACT

A driving method comprising: acquiring a first grayscale value of each of the plurality of pixels in a current display frame; acquiring an area identifier of each of the plurality of pixels and a light-intensity of a surrounding environment, the plurality of pixels comprising at least two kinds of area identifiers, each of the plurality of pixels having a light reflectivity, the area identifier of each of the plurality of pixels being set according to the light reflectivity; converting the first grayscale value of each of the plurality of pixels into a second grayscale value according to the area identifier and the light-intensity of the surrounding environment; and driving the display device to display images according to the second grayscale value of each of the plurality of pixels. The driver and the display device are also provided.

### FIELD

The subject matter herein relates to a driving method, a driver using the driving method, and a display device using the driver.

### BACKGROUND

A traditional display device includes displaying images and function modules (such as an under-screen fingerprint-sensing module) under a transparent cover.

In a high brightness environment, a light reflectivity of an area of the transparent cover corresponding to the function module is lower than that of other areas of the transparent cover not corresponding to the function module, which makes the function module becomes observable by human eyes. An image of the function module overlaps with the images displayed by the transparent cover, which affects the images displayed by the transparent cover.

Therefore, there is room for improvement in the art.

### BRIEF DESCRIPTION OF THE DRAWINGS

Implementations of the present disclosure will now be described, by way of embodiment, with reference to the attached figures.

FIG. 1 is a perspective view of a display device having a driver according to an embodiment of the disclosure.

FIG. 2 is a planar view of the display device shown in FIG. 1.

FIG. 3 is a block diagram of the driver in FIG. 1.

FIG. 4 is a flow chart of a driving method according to an embodiment of the disclosure.

FIG. 5 is another planar view of the display device shown in FIG. 1.

FIG. 6 is a planar view of a display device according to another embodiment of the disclosure.

### DETAILED DESCRIPTION

It will be appreciated that for simplicity and clarity of illustration, where appropriate, reference numerals have been repeated among different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” when utilized, means “including, but not necessarily limited to”; it specifically indicates open-ended inclusion or membership in the so-described combination, group, series, and the like. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape, or other word that the term modifies, such that the component need not be exact. For example, “substantially cylindrical” means that the object resembles a cylinder, but can have one or more deviations from a true cylinder.

When a feature or element is herein referred to as being “on” another feature or element, it can be directly on the other feature or element or intervening features and/or elements may also be present. It will also be understood that, when a feature or element is referred to as being “connected”, “attached”, or “coupled” to another feature or element, it can be directly connected, attached, or coupled to the other feature or element or intervening features or elements may be present.

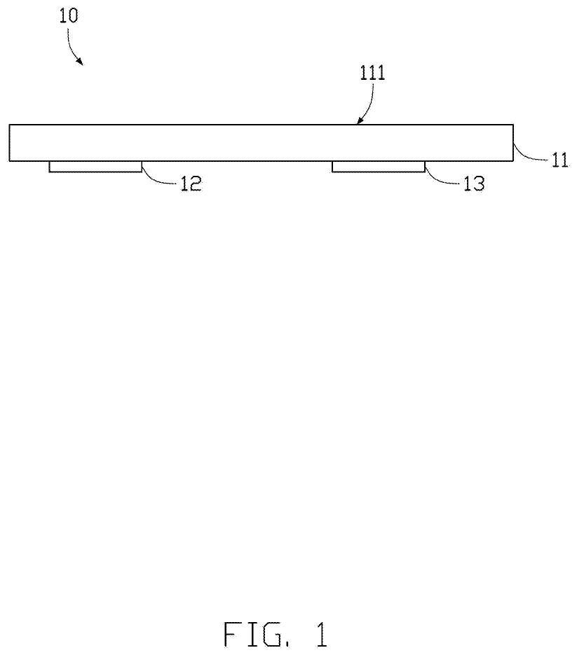

FIG. 1 shows a display device 10 of an embodiment. The display device 10 includes a display panel 11 and a driver 12 electrically connected to the display panel 11. The display panel 11 may be an organic light-emitting diode (OLED) display panel, a liquid crystal display (LCD) panel, a micro light-emitting diode (Micro LED) display panel, or an electronic ink (E-Ink) display panel. The display panel 11 has a display surface 111 for showing images. The driver 12 is on a side of the display panel 11 away from the display surface 111 and is configured to drive the display panel 11 to display the images. The display device 10 also includes conventional structures, such as a backlight module, and an outer frame if the display device 10 is an LCD panel, which are not shown in FIG. 1.

The display device 10 further includes a functional module 13 on the side of the display panel 11 away from the display surface 111. The functional module 13 may be an optical under-screen fingerprint-recognizing module, an ultrasonic under-screen fingerprint-recognizing module, a light-sensing module, or a touch-control module, etc.

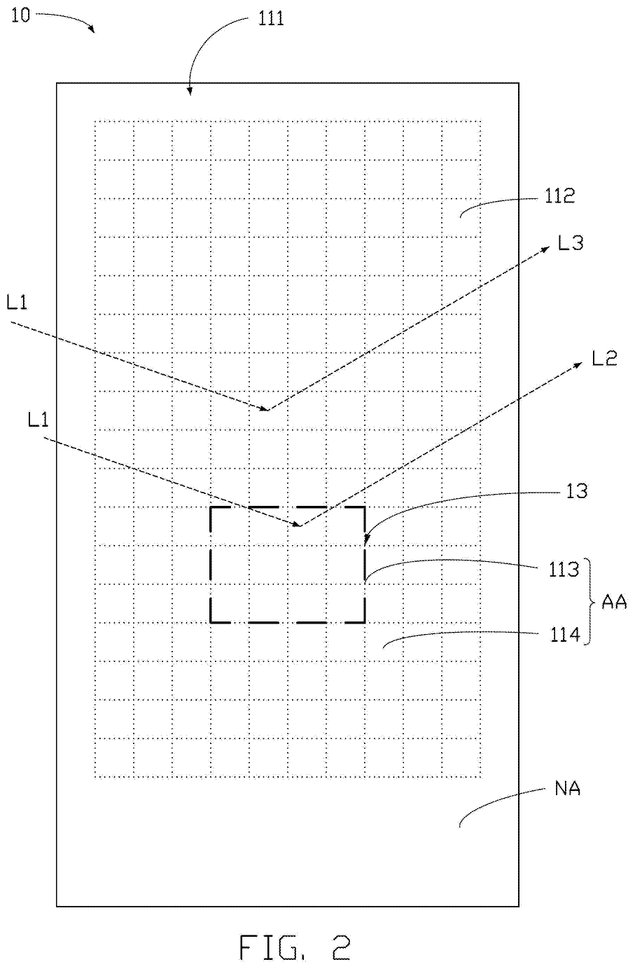

FIG. 2 shows the display panel 11, which defines a display area AA at the center of the surface 111 and a non-display area NA surrounding the display area AA. The display area AA and the non-display area NA form the display surface 111. The display area AA is configured to display the images. The display area AA defines a plurality of pixels 112 arranged in an array. The display panel 11 works by using display frames. Each “display frame” represents a time period during which the display device 10 displays a frame of image. Each image displayed by the display panel 11 in each display frame is a combination of outputs of light by the plurality of pixels 112.

An orthographic projection of the functional module 13 on the display area AA is defined as a projection area 113. An area of the display area AA other than the projection area 113 is defined as a non-projection area 114. An ambient light L1 reaching the projection area 113 is reflected by the projection area 113 as a first reflected light L2, and an ambient light L1 reaching the non-projection area 114 is reflected by the non-projection area 114 as a second reflection light L3. A light reflectivity of the projection area 113 is lower than that of the non-projection area 114 because of the functional module 13, which reduces intensity of the first reflected light L2 so as to make it lower than that of the second reflected light L3. That is, intensities of reflected lights emitted from the projection area 113 and the non-projection area 114 are not the same when intensities of ambient lights reaching the projection area 113 and the non-projection area 114 are the same, which results in non-uniform light-intensity distribution of images in the display area AA observed by human eyes.

In this embodiment, the driver 12 resolves the problem of non-uniform light-intensity distribution of the images observed by the human eyes in the display area AA.

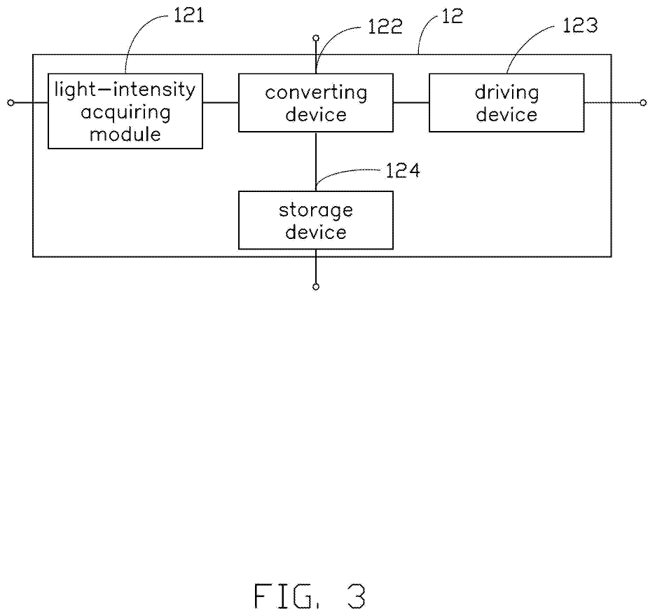

FIG. 3 shows the driver 12 including a light-intensity acquiring device 121, a converting device 122 electrically connected to the light-intensity acquiring device 121, a driving device 123 electrically connected to the converting device 122, and a storage device 124 electrically connected to the converting device 122.

The light-intensity acquiring device 121 is configured to acquire an intensity of ambient light of surrounding environment during a current display frame. In another embodiment, the functional module 13 is a light-sensing module, the light-intensity acquiring device 121 and the functional module 13 are one and the same structure in the display device 10.

The storage device 124 is configured to store a plurality of grayscale-lookup tables. Each grayscale-lookup table maps the relationship of a plurality of first grayscale values and a plurality of second grayscale values. Mapping relationships of the plurality of grayscale-lookup tables are each different. The mapping relationships may be, for example, inversion, binarization, or linear transformation. That is, each grayscale-lookup table is configured to record the plurality of second grayscale values obtained by operations such as inversion, binarization, or linear transformation from the plurality of first grayscale values.

Each pixel 112 corresponds to one grayscale-lookup table, and the grayscale-lookup table corresponding to the pixel 112 is defined as a target grayscale-lookup table of the pixel 112. Each pixel 112 includes a plurality of sub-pixels (not shown), each target grayscale-lookup table includes a plurality of target grayscale-lookup sub-tables, and each sub-pixel corresponds to one target grayscale-lookup sub-table. Each target grayscale-lookup sub-table maps the relationship of the first grayscale values and the second grayscale values of that sub-pixel.

The plurality of first grayscale values are the grayscale values carried in original image signals in the display panel 11, and the plurality of second grayscale values are grayscale values as calculated by the driver 12 after processing for image compensation. The driver 12 drives the display panel 10 to display the images according to the plurality of second grayscale values, which reduces unevenness of light-intensity distribution in the display area AA observed by the human eyes.

In this embodiment, the display area AA is divided into two areas (the projection area 113 and the non-projection area 114) according to different light reflectivity. In other embodiments, the display area AA may be divided into other areas according to different light reflectivity. The above-mentioned different light reflectivities means that light reflectivity of different areas are in different numerical ranges. For example, pixels 112 with light reflectivity between 80% and 90% can be divided into one area. One pixel 112 can be regarded as and divided into one area. Pixels 112 in the same area all have the same area identifier, pixels 112 in different areas after being divided have different area identifiers. In this embodiment, the area identifiers are Arabic numerals. In other embodiments, the area identifiers may be represented by letters, other types of characters, or character strings.

Different area identifiers correspond to different grayscale-lookup tables, and different ambient light-intensities correspond to different grayscale-lookup tables. In defining a plurality of numerical ranges, values of light intensities within a same numerical range correspond to the same grayscale-lookup table, and values of light intensities in different numerical ranges correspond to different grayscale-lookup tables.

The converting device 122 obtains first grayscale values of each pixel 112 during the current display frame, and determine target grayscale-lookup tables from the plurality of grayscale-lookup tables according to area identifiers of each pixel 112 and ambient light-intensity during the current display frame. Each pixel 112 corresponds to one target grayscale-lookup table. The converting device 122 converts the first grayscale value corresponding to each pixel 112 into the second grayscale value according to the mapping relationships stored in the target grayscale-lookup tables.

The driving device 123 drives the display panel 11 to display the images according to the plurality of second grayscale values. In this embodiment, the storage device 124 is also configured to store a plurality of tables relating a certain grayscale to a certain voltage (grayscale to voltage-lookup tables, or GTV tables). Each GTV table maps relationship between second grayscale values and driving voltages. According to the second grayscale values, the driving device 123 can search for a value of the driving voltage corresponding to a second grayscale value of each pixel 112 from the GTV table. Each pixel 112 is driven to display images with the driving voltage. The display panel 11 includes a plurality of pixel electrodes (not shown) corresponding to the plurality of sub-pixels in a one-to-one manner, and the driving device 123 outputs the driving voltages to the pixel electrodes to drive the display panel 11 to display the images.

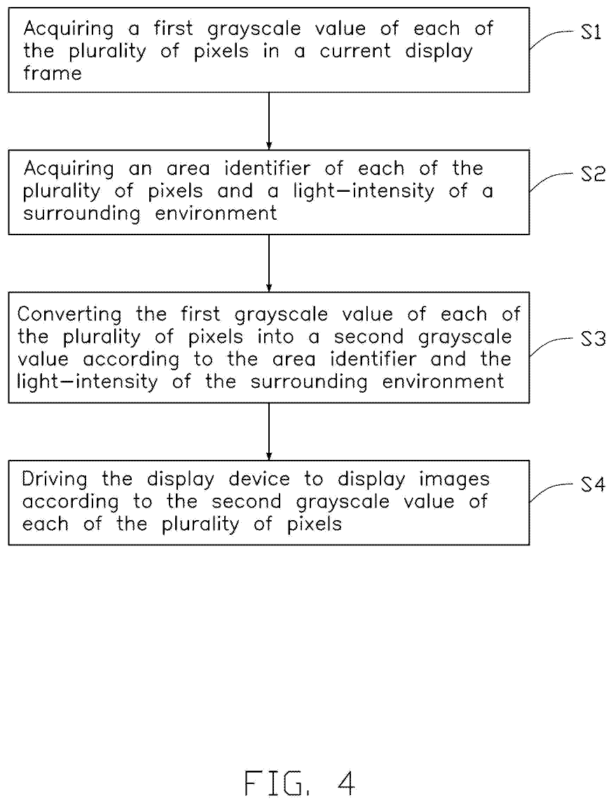

This embodiment also provides a driving method applied to the display device 10, specifically, being applied to the driver 12. Referring to FIG. 4, a flowchart of such driving method is presented in accordance with an example embodiment. The example method is provided by way of example, as there are a variety of ways to carry out the method. The method described below can be carried out using the configurations illustrated in FIGS. 1-3, for example, and various elements of these figures are referenced in explaining example method. Each block shown in FIG. 4 represents one or more processes, methods or subroutines, carried out in the exemplary method. Additionally, the illustrated order of blocks is by example only and the order of the blocks can change. The exemplary method can begin at block S1 and includes:

block S1, acquiring a first grayscale value of each of the plurality of pixels in a current display frame;

block S2, acquiring an area identifier of each of the plurality of pixels and a light intensity of a surrounding environment;

block S3, converting the first grayscale value of each of the plurality of pixels into a second grayscale value according to the area identifier and the light-intensity of the surrounding environment; and

block S4, driving the display device to display images according to the second grayscale value of each of the plurality of pixels.

In block S1, a display signal carries image information during the current display frame. The image information includes the plurality of first grayscale values of each pixel 112 during the current display frame. In this embodiment, one pixel 112 includes three sub-pixels, the three sub-pixels each emitting light in different colors. Each first grayscale value is expressed as (X₁, Y₁, Z₁), wherein X₁, Y₁, Z₁ are first grayscale values of the three sub-pixels during the current display frame.

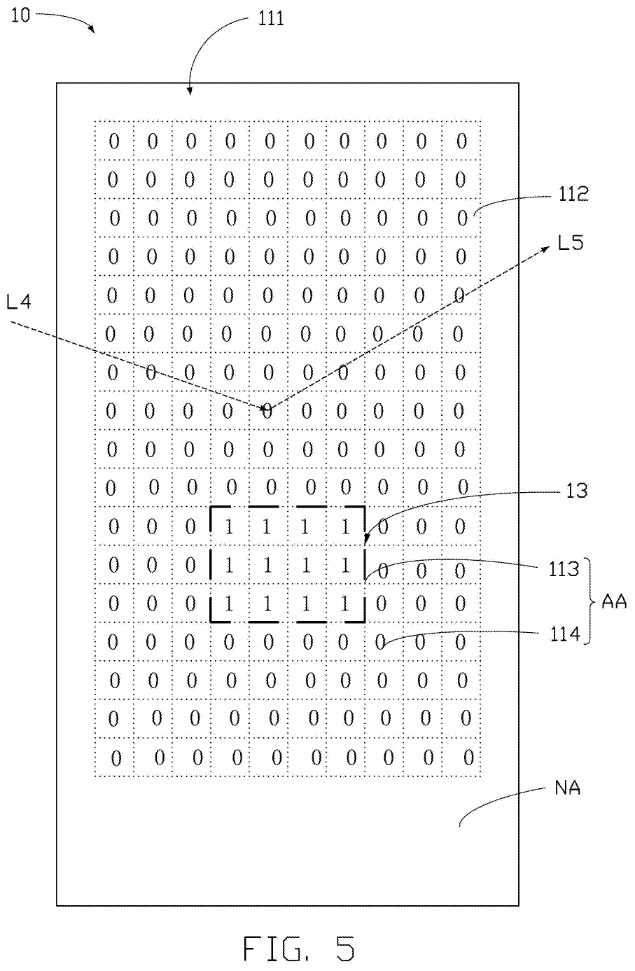

Each pixel 112 has a unique area identifier. FIG. 5 shows the display device 10, and in this embodiment, each area identifier is represented by Arabic numerals, each pixel 112 in the projection area 113 is configured with an area identifier 1, and each pixel 112 in the non-projection area 114 is configured with an area identifier 0.

The following describes the configuring of the area identifier of each pixel 112.

Area identifiers of each pixel are determined according to light reflectivity of each pixel.

Acquiring the light reflectivity of each pixel 112 may include: emitting a reference beam L4 to the display area AA, and a photodetector (not shown) receiving a beam (detection beam L5) reflected by the display area AA, a ratio between light intensity of the reference beam L4 and light intensity of the detection beam L5 being defined as the light reflectivity. The light reflectivity of each pixel 112 can be measured by separately detecting the light intensities of the reference beam L4 and the detection beam L5 emitted by each pixel 112 and calculating the ratio.

The pixels 112 are grouped according to the light reflectivities based on a preset rule. The pixels 112 are divided into at least two groups. Each pixel 112 belonging to one group is configured with a same area identifier, other groups of pixels 112 are each configured with different area identifiers. Pixels 112 with a light reflectivity within a certain range are placed into one group, for example, pixels with light refractivity between 80% and 85% are divided into a first group, pixels with light refractivity between 85% and 90% are divided into a second group.

In this exemplary embodiment, the pixels 112 are divided into two groups. Pixels 112 in the projection area 113 are divided into one group and have the same area identifier 1 (one). Pixels 112 in the non-projection area 114 are divided into another group and have the same area identifier 0 (zero).

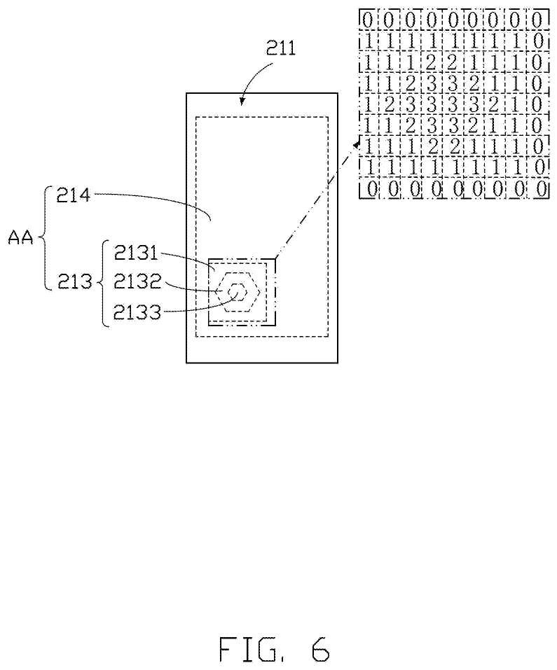

FIG. 6 shows a display device of another embodiment of the disclosure, wherein the display area AA is divided into a projection area 213 and a non-projection area 214. The projection area 213 is the area where the function module 23 is below or fixed to the surface 211. Different parts of the functional module 23 are formed of different materials, which results in different light reflectivities of areas corresponding to each part of the functional module 23 in the projection area 213. The projection area 213 includes three projection sub-areas 2131, 2132, and 2133. Each projection sub-area corresponds to one part of the functional module 23. Area identifier of each pixel 212 in the non-projection area 214 is 0, the area identifier of each pixel 212 in the projection sub-area 2131 is 1. Further, area identifier of each pixel 212 in the projection sub-area 2132 is 2, and area identifier of each pixel 212 in the projection sub-area 2133 is 3.

In block S2, the acquiring of the ambient light intensity of the surrounding environment during the current display frame can be achieved through a light sensing module inside the display device 10 (for example, the functional module 13 shown in FIG. 1). The light sensing module is configured for real-time detection of the ambient light intensity.

Block S3 specifically includes: acquiring a target grayscale-lookup table of each of the plurality of pixels from the grayscale-lookup tables according to the area identifier of each of the pixels and the light-intensity of the surrounding environment.

Block S3 further includes: converting the first grayscale value of each of the pixels into the second grayscale value according to the target grayscale-lookup table of each of the pixels.

Each grayscale-lookup table corresponds to a certain light-intensity range and a unique area identifier. Each light-intensity range corresponds to at least two grayscale-lookup tables, and each area identifier corresponds to at least two grayscale-lookup tables. The light-intensity a numerical range of the ambient light intensity of the surrounding environment during the current display frame. The number of grayscale-lookup tables stored in the display device 10 is equal to the number of different permutations of the numerical ranges and the area identifiers. That is, if there are m numerical ranges defined for ambient light-intensity and there are n area identifiers defined, the number of grayscale-lookup tables stored in the display device 10 is m*n.

In this embodiment, two area identifiers (0 and 1) and three light-intensity ranges are defined, thereby the display device 10 stores 2*3=6 grayscale-lookup tables. There are 6 possible permutations of two area identifiers and three light-intensity ranges, each of the 6 permutations corresponds to a unique grayscale-lookup table. Each pixel 112 has an area identifier, and if the ambient light intensity of the current display frame is known, then the target grayscale-lookup table corresponding to each pixel 112 can be uniquely determined from the plurality of grayscale-lookup tables.

Each second grayscale value is expressed as (X₂, Y₂, Z₂), thus X₂=f(X₁), Y₂=f(Y1), and Z₂=f(Z₁) where f is the mapping relationship recorded in the target grayscale-lookup table. Each target grayscale-lookup table includes target grayscale-lookup sub-tables, and each sub-pixel corresponds to one target grayscale-lookup sub-table. That is, each target grayscale-lookup sub-table maps the relationship between the first and second grayscale values in relation to light of one color.

In this embodiment, I₀ represents the ambient light-intensity, and the Xₘₐₓ, Yₘₐₓ, and Zₘₐₓ represent the maximum grayscale values of the display device 10. Iₘₐₓ represents the maximum brightness that each pixel can display (that is, the brightness at the maximum grayscale value), n₁ represents the light reflectance of each pixel 112 whose area identifier is 0, and n₂ represents the light reflectance of each pixel 112 whose area identifier is 1. In the target grayscale-lookup table corresponding to each pixel with the area identifier 1, the mapping relationship between the first grayscale values and the second grayscale values is:

$$\begin{matrix}{X}_{2} = {\{ \frac{[ {( \frac{{X}_{1}}{{X}_{ma x}} )}^{γ} * {1}_{max} + {{I}_{0}}^{*} {n}_{1} ] - {{I}_{0}}^{*} {n}_{2}}{{I}_{ma x}} \}}^{\frac{1}{γ}} & ( 1 ) \\ {Y}_{2} = {\{ \frac{[ {( \frac{{Y}_{1}}{{Y}_{ma x}} )}^{γ} * {1}_{max} + {{I}_{0}}^{*} {n}_{1} ] - {{I}_{0}}^{*} {n}_{2}}{{I}_{ma x}} \}}^{\frac{1}{γ}} & ( 2 ) \\ {Z}_{2} = {\{ \frac{[ {( \frac{{Z}_{1}}{{Z}_{ma x}} )}^{γ} * {1}_{max} + {{I}_{0}}^{*} {n}_{1} ] - {{I}_{0}}^{*} {n}_{2}}{{I}_{ma x}} \}}^{\frac{1}{γ}} . & ( 3 )\end{matrix}$$

In this embodiment, the maximum grayscale value of the display device 10 is 255. A light-emitting brightness of each sub-pixel is 600 nits when the sub-pixel is at the maximum grayscale value; the y value of the display device 10 is 2.2; I₀*n₁=100 nits; I₀*n₂=60 nits. According to the above mapping relationships (1), (2), (3), when the first grayscale value of a certain sub-pixel is 155:

the second grayscale value is:

$${\{ \frac{[ {( \frac{155}{255} )}^{2.2} * 600 + 100 ] - I 60}{600} \}}^{\frac{1}{2.2}} = 168 .$$

That is, in the target grayscale-lookup table corresponding to the sub-pixel, the first grayscale value of 155 corresponds to the second grayscale value of 168.

Block S4 specifically includes:

acquiring a plurality of driving voltages according to the plurality of second grayscale values, and driving the plurality of pixels by the driving voltages to make the display device display the images, each driving voltage corresponding to one second grayscale value.

During each display frame, the driver 12 repeats the above method to drive the display device 10 to display images.

The plurality of first grayscale values are grayscale values carried in original image signals in the display panel 11, and the plurality of second grayscale values are grayscale values calculated by the driver 12 after image compensation processing. A specific calculation process is embodied in the above-mentioned mapping relationships. Therefore, for different light reflectivity and different ambient light intensities, there are different grayscale-lookup tables corresponding to different mapping relationships. Therefore, driving the display panel to display the images according to the second grayscale values calculated after the image compensation processing reduces if not resolves the problem of uneven light-intensity distribution of the images observed by the human eyes in the display area AA.

The driving method uses the driver 12, and the display device 10 provided in this embodiment, configures the area identifiers to each pixel 112 according to the light reflectivity of each pixel 112, and acquires the ambient light-intensity in real time, converting the first grayscale values of each pixel 112 during the current display frame into the second grayscale values according to the area identifiers and the ambient light-intensity, and driving the display device 10 to display the images according to the second grayscale values. Wherein, the first grayscale values are the grayscale values carried in the original image signal, and the second grayscale values are grayscale values calculated after the image compensation based on the area identifier (directly related to the light reflectivity) and the ambient light-intensity.

Since the light emitted from each pixel 112 includes not only light emitted by the display device 10 itself for displaying images, but also the ambient light reflected by the surface 111. This disclosure takes account of the ambient light-intensity as an influencing factor when converting the first grayscale values into the second grayscale values, to improve a perceived accuracy of the conversion of the first grayscale values and the second grayscale values.

It is to be understood, even though information and advantages of the present embodiments have been set forth in the foregoing description, together with details of the structures and functions of the present embodiments, the disclosure is illustrative only. Changes may be made in detail, especially in matters of shape, size, and arrangement of parts within the principles of the present embodiments to the full extent indicated by the plain meaning of the terms in which the appended claims are expressed.

What is claimed is:

1. A driving method, applicable in a display device defining a plurality of pixels and operable in a plurality of display frames, wherein the driving method comprises:
acquiring a first grayscale value of each of the plurality of pixels in a current display frame;
acquiring an area identifier of each of the plurality of pixels and a light-intensity of a surrounding environment, the plurality of pixels comprising at least two kinds of area identifiers, each of the plurality of pixels having a light reflectivity, the area identifier of each of the plurality of pixels being set according to the light reflectivity;
converting the first grayscale value of each of the plurality of pixels into a second grayscale value according to the area identifier and the light-intensity of the surrounding environment; and
driving the display device to display images according to the second grayscale value of each of the plurality of pixels.

2. The driving method of claim 1, wherein the display device storages a plurality of grayscale-lookup tables; wherein converting the first grayscale value of each of the plurality of pixels into a second grayscale value comprises:
acquiring a target grayscale-lookup table of each of the plurality of pixels from the plurality of grayscale-lookup tables according to the area identifier of each of the plurality of pixels and the light-intensity of the surrounding environment; and
converting the first grayscale value of each of the plurality of pixels into the second grayscale value of each of the plurality of pixels according to the target grayscale-lookup table of each of the plurality of pixels.

3. The driving method of claim 2, wherein each of the plurality of grayscale-lookup tables corresponds to a unique light-intensity range and a unique area identifier.

4. The driving method of claim 3, wherein each light-intensity range corresponds to at least two grayscale-lookup tables, and each of the area identifier corresponds to at least two grayscale-lookup tables.

5. The driving method of claim 1, wherein driving the display device to display images according to the second grayscale value of each of the plurality of pixels comprises:
acquiring a driving voltage of each of the plurality of pixels according to the second grayscale value of each of the plurality of pixels, driving each of the plurality of pixels with the driving voltages to make the display device displaying the images.

6. A driver applied in a display device defining a plurality of pixels and working in a plurality of display frames; the driver comprising:
a light-intensity acquiring device being configured to acquire an ambient light intensity of a surrounding environment;
a converting device electrically connected to the light-intensity acquiring device, the converting device being configured to acquire the first grayscale value of each of the plurality of pixels during a current display frame, and configured to convert the first grayscale value of each of the plurality of pixels into the second grayscale value of each of the plurality of pixels according to the ambient light intensity and the area identifier of each of the plurality of pixels, the plurality of pixels comprising at least two kinds of area identifiers, each of the plurality of pixels having a light reflectivity, the area identifier of each of the plurality of pixels being set according to the light reflectivity; and
a driving device electrically connected to the converting device, the driving device being configured for driving the display device to display images according to the second grayscale value of each of the plurality of pixels.

7. The driver of claim 6, further comprising:
a storage device electrically connected to the converting device, the storage device being configured for storing a plurality of grayscale-lookup tables;
wherein the converting device is further configured to determine a target grayscale-lookup table of each of the plurality of pixels from the plurality of grayscale-lookup tables according to the area identifier of each of the plurality of pixels and the ambient light intensity, and configured to convert the first grayscale value of each of the plurality of pixels into the second grayscale value of each of the plurality of pixels according to the target grayscale-lookup table of each of the plurality of pixels.

8. A display device, operable in a plurality of display frames, comprising:
a display panel defining a plurality of pixels, each of the plurality of pixels having an area identifier; and
a driver comprising:
a light-intensity acquiring device being configured to acquire an ambient light intensity of a surrounding environment;
a converting device electrically connected to the light-intensity acquiring device, the converting device being configured to acquire the first grayscale value of each of the plurality of pixels during a current display frame, and configured to convert the first grayscale value of each of the plurality of pixels into the second grayscale value of each of the plurality of pixels according to the ambient light intensity and the area identifier of each of the plurality of pixels, the plurality of pixels comprising at least two kinds of area identifiers, each of the plurality of pixels having a light reflectivity, the area identifier of each of the plurality of pixels being set according to the light reflectivity; and
a driving device electrically connected to the converting device, the driving device being configured for driving the display device to display images according to the second grayscale value of each of the plurality of pixels.

9. The display device of claim 8, wherein the driver further comprises:
a storage device electrically connected to the converting device, the storage device being configured for storing a plurality of grayscale-lookup tables;
wherein the converting device is further configured to determine a target grayscale-lookup table of each of the plurality of pixels from the plurality of grayscale-lookup tables according to the area identifier of each of the plurality of pixels and the ambient light intensity, and configured to convert the first grayscale value of each of the plurality of pixels into the second grayscale value of each of the plurality of pixels according to the target grayscale-lookup table of each of the plurality of pixels.

10. The display device of claim 8, further comprising a functional module on a side of the display panel having the driver;
wherein pixels corresponding to a projection of the functional module on the display panel have a same area identifier.

11. The display device of claim 10, wherein the driver further comprises:
a storage device electrically connected to the converting device, the storage device being configured for storing a plurality of grayscale-lookup tables;
wherein the converting device is further configured to determine a target grayscale-lookup table of each of the plurality of pixels from the plurality of grayscale-lookup tables according to the area identifier of each of the plurality of pixels and the ambient light intensity, and configured to convert the first grayscale value of each of the plurality of pixels into the second grayscale value of each of the plurality of pixels according to the target grayscale-lookup table of each of the plurality of pixels.

12. The display device of claim 8, wherein the functional module may be an optical under-screen fingerprint-recognizing module, an ultrasonic under-screen fingerprint-recognizing module, a light-sensing module, or a touch-control module.

13. The display device of claim 12, wherein the driver further comprises:
a storage device electrically connected to the converting device, the storage device being configured for storing a plurality of grayscale-lookup tables;
wherein the converting device is further configured to determine a target grayscale-lookup table of each of the plurality of pixels from the plurality of grayscale-lookup tables according to the area identifier of each of the plurality of pixels and the ambient light intensity, and configured to convert the first grayscale value of each of the plurality of pixels into the second grayscale value of each of the plurality of pixels according to the target grayscale-lookup table of each of the plurality of pixels.
